(19) United States
(12) Patent Application Publication
(10) Pub. No.: US 2013/0069381 A1
(43) Pub. Date: Mar. 21, 2013

(54) CARRYING CASE

(71) Applicant: Mitsuru Sakamoto, Kanagawa (JP)

(72) Inventor: Mitsuru Sakamoto, Kanagawa (JP)

(73) Assignee: JB TRUST INC., Kanagawa (JP)

(21) Appl. No.: 13/701,852

(22) PCT Filed: May 18, 2011
(86) PCT No.: PCT/JP2011/002762

§ 371 Date: Dec. 4, 2012

(30) Foreign Application Priority Data
Jun. 4, 2010 (JP) 2010-128714

(51) Int. Cl. F16M 13/04

(52) U.S. Cl. CPC F16M 13/04
USPC 294/142; 294/137; 294/167

(57) ABSTRACT

This invention is to provide a carrying case for a portable electronic terminal device such as a tablet media player or a tablet media computer having a constitution which can be held by a hand, and thus, a carrying case according to the present invention comprises a mounting main body for mounting and fixing a portable electronic terminal device having a screen with a specific size which is an information displaying screen and a touch input screen, a handle portion rotatably held to said mounting main body; and an arm portion fixed on said handle portion and holding a hand or an arm of a user between the handle portion and itself.

### TECHNICAL FIELD

The present invention relates to a carrying case for a portable electronic terminal device such as a tablet media player, a tablet computer which has a screen with a specific size for displaying information and can be input by touching pictures displayed on the screen.

### BACKGROUND OF THE INVENTION

The Patent Document No. 1 discloses a portable electronic terminal device for unitizing by combining a portable electronic terminal device and a communication device for information data electrically and mechanically. The portable information terminal device comprises a portable electronic terminal device which is provided with a touch sensitive screen for inputting and displaying various information on an upper surface of a case for terminal and an interface for inputting/outputting at a specific position of the case for terminal, and a communication device for transmitting information data input from the electronic terminal device to the other electronic device and outputting the data information input from the electronic terminal device to the electronic terminal device by installing a wireless data communication part or the like in a main body case and connecting to the electronic terminal device electrically. In the portable information terminal device, an installation part on which the electronic terminal device can be installed on an upper surface thereof is defined on the main body case, a bulge part extending in a horizontal direction is projected and formed on a front edge part of the installation part, an engaging piece projecting approximately horizontally to the installation part (backward) is formed integrally on a rear end corner part of the upper surface of the bulge part, and further the engaging piece is set so as to engage a concave part of a front end corner part on the upper surface of the case for terminal when the electronic terminal device is positioned on the installation part, so that a front part of the main body case and a front end part of the electronic terminal device are engaged mechanically each other.

The patent document No. 2 discloses a portable information processing device which is provided with a portable information terminal providing a displaying surface in a front surface side, an antenna unit for receiving signals transmitted from GPS satellite, and a detachable function which can detach the antenna unit from the portable information terminal without changing a projected area from a side of the displaying surface. The portable information processing device has a flat box type of main body housing, wherein an LCD unit (Liquid Cristal Display Unit) for outputting display on the surface side and a digitalizing unit (a touch panel) for input are arranged in piles.

The patent document No. 3 discloses a case for a portable terminal which is constituted of a case main body whose upper part is opened, to which a portable terminal is detachable and on which the portable terminal can be operated, a connector which is located at one side in the case main body and connected to the portable terminal, a secondary battery which can supply electric power to the portable terminal via the connector, a solar battery for charging the secondary battery, a plurality of display parts for displaying amount of charge in the secondary battery and a switch for controlling electric power movement from the secondary battery to the potable terminal, wherein the solar battery is fixed on a back surface of the case main body to generate electric power by receiving sunlight and charge the secondary battery, wherein the displaying parts are located at a viewable position in a side end surface of the case main body and display an amount of charge in the secondary battery and display a supply condition of electric power to the portable terminal and wherein the switch is controlled according to a remaining amount of electric power in the portable terminal in order to supply electric power in the secondary battery to the portable terminal.

### PRIOR ART DOCUMENTS

### Patent Documents

Patent Document No. 1: JP H10-207576 A
Patent Document No. 2: JP 2007-68219 A
Patent Document No. 3: JP 2010-110195 A

### SUMMARY OF THE INVENTION

### Problem to be Solved by the Invention

As described above, an object of the prior portable terminal case is to add various functions to a portable terminal, and because the case itself comprises devices corresponding to the added functions, the case's own weight becomes heavy, so that there was problem such that it is not convenient to carry it.

Recently, in order to make display of information better and to make input easier, a portable electronic terminal device provided with a certain level of size was developed, and it became a huge hit. However, this portable electronic terminal device has any inconvenience such that it is inconvenient to carry it and that it is too large to carry it in one hand because it has a specific size though it is superior in operability and in display performance.

Thus, the present invention is to provide a carrying case for a portable electronic terminal device, which has a constitution such as to be able to hold the portable electronic terminal device such as a tablet media player and a tablet computer by one hand.

### Means for Solving Problem

Accordingly, a carrying case according to the present invention is to comprise a mounting main body to which a portable electronic terminal device having a screen with a specific size that is used as an information display screen and a touch input screen is mounted and secured, a handle portion rotatably retained to the mounting main body and an arm portion which is secured to the handle portion and which holds a hand or an arm of a user in cooperation with the handle portion.

Thus, the portable electronic terminal device can be held in one hand by mounting and securing the portable electronic terminal device to the mounting main body and inserting the hand or the arm of the user between the handle portion and the arm portion. Besides, because the handle portion and the arm portion are rotatable to the mounting main body, it becomes possible to hold and use the portable electronic terminal device in a vertical direction or in a horizontal direction. Furthermore, the handle portion is formed to a specific size and thus it may be constituted so as to grip it by the hand.

Furthermore, it is preferred that the arm portion is constituted of a bridge portion whose both ends are fixed on the handle portion and which is defined a space where a hand or an arm of the user can be inserted and an elastic portion provided on the bridge portion and contacting the hand or the arm of the user elastically. Moreover, the bridge portion is preferably formed united with the handle portion.

Besides, the arm portion is preferably constituted of a pair of fixing portions detachable to the handle portion and a belt portion located between the fixing portions and made of an elastic material holding the hand or the arm of the user and preferably detachable to the handle portion.

Furthermore, a part of the arm portion is preferably a stand portion which is held rotatably to one end of the arm portion and can be opened at a specific angle.

Furthermore, the handle portion is preferably detachable to the mounting main body. Thus, in the case that the handle portion and the arm portion are not necessary, the handle portion can be removed without removing the mounting main body from the portable electronic terminal device.

A detachable mechanism for making it detachable is preferably constituted of a base portion and a rotation fixing portion formed in the handle portion and engaging the base portion. In this mechanism, the base portion is constituted of a disc embedded in the mounting main body, a shaft portion extending from the embedded disc, first and second discs extending in a radial direction from the shaft portion and an engaged concave portion formed between the first and the second discs, and the rotation fixing portion is constituted of engaging convex portions installed movable to the engaged concave portion, springs for biasing the engaging convex portions against the engaged concave portion and knobs for removing the engaging convex portions from the engaged concave portion.

### Effect of the Invention

Due to the carrying case according to the present invention, because the hand or the arm of the user can inserted into and held between the handle portion and the arm portion, since the portable electronic terminal device fixed in the mounting main body can be held horizontally or vertically, the portable electronic terminal device can be held and operated by a hand safely, so that the present invention has an effect such that the user can use it safely.

### BRIEF EXPLANATION OF THE DRAWINGS

FIG. 1 is a schematic diagram showing a carrying case according to an embodiment No. 1 of the present invention;

FIG. 2A is a usage example showing that the portable electronic terminal device is held horizontally and FIG. 2A is a usage example showing that the portable electronic terminal device is held vertically;

FIG. 3 is a schematic diagram showing a carrying case according to an embodiment No. 2 of the present invention;

FIG. 4 is an exploded view of the carrying case according to the embodiment No. 2 of the present invention;

FIG. 5A is a plan view of the detachable mechanism, FIG. 5B is a cross-sectional side view of the handle portion and FIG. 5C is a perspective view of a base portion; and

FIG. 6 is a schematic diagram showing a condition of standing the portable electronic terminal device.

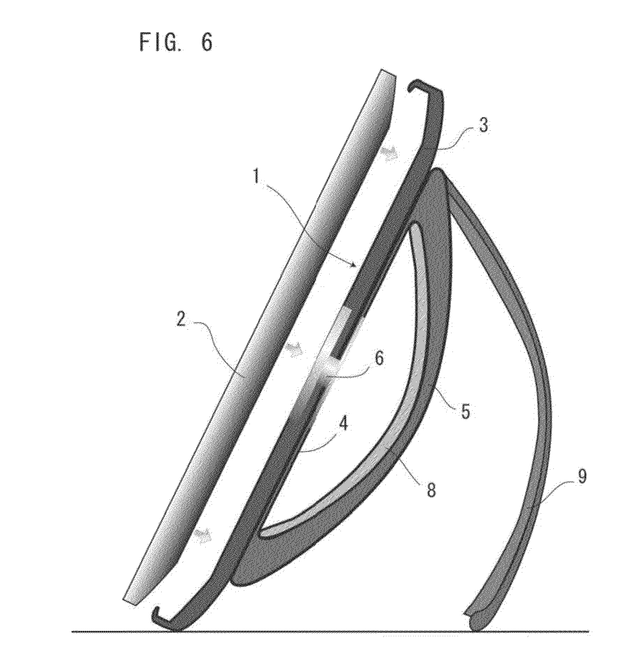

### MODE FOR CARRYING OUT THE INVENTION

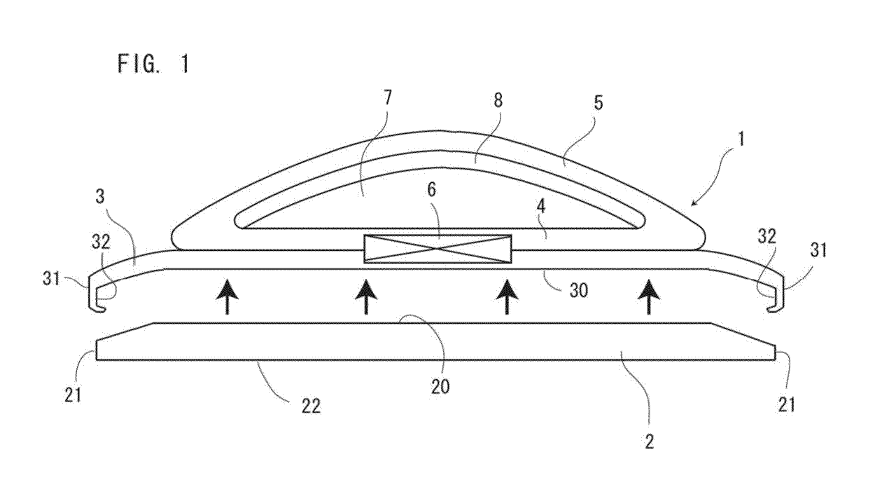

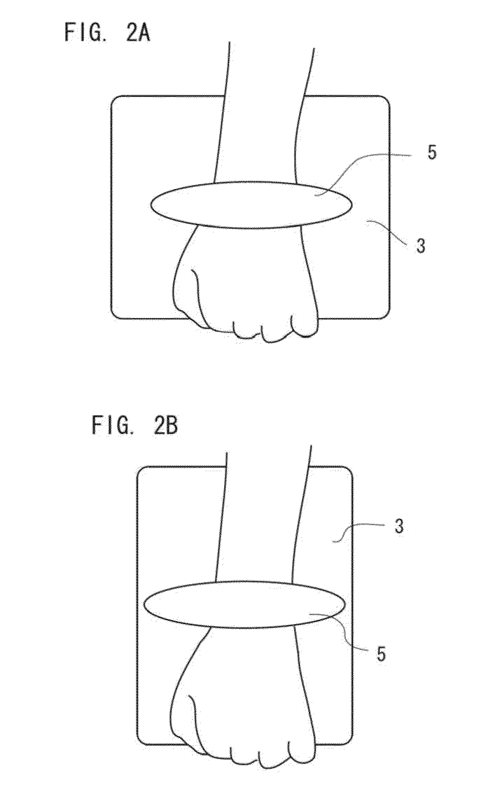

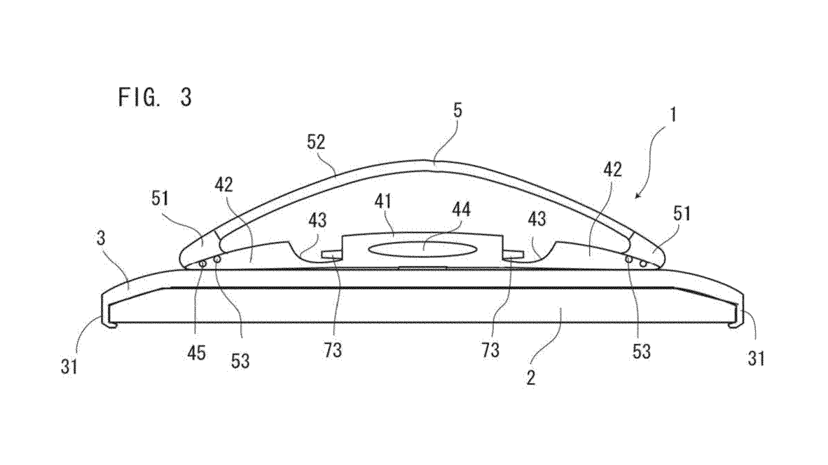

As shown in FIGS. 1 and 3, a carrying case 1 according to the present invention is constituted of a mounting main body 3 for mounting a portable electronic terminal device 2 such as a tablet media player or a tablet type computer having a screen with a specific size being an information displaying screen and a touch input screen, a handle portion 4 rotatably held via a rotation mechanism 6 to the mounting main body 3 and an arm portion 5 secured on the handle portion 4 and holding a hand or an arm of a user between the handle portion and itself. Thus, as shown in FIGS. 2A and 2B, the mounting main body 3 holding the portable electronic terminal device 2 can be carried horizontally or vertically. Hereinafter, embodiments according to the present invention are explained by referring the drawings.

### Embodiment No. 1

The carrying case 1 according to the embodiment No. 1 of the present invention comprises the mounting main body 3 installing and fixing the portable electronic terminal device 2. The mounting main body 3 has an inner-side surface 30 with a figuration corresponding to a back surface 20 (an opposite surface of a display screen 22) of the portable electronic terminal device 2, and a peripheral edge fixing portion 31 for mounting a peripheral surface portion 21 of the portable electronic terminal device 2 is formed on a peripheral edge thereof. In this embodiment No. 1, the peripheral edge portion 31 is formed with elastic material so as to be engaged to the peripheral edge portion 21. However, the portable electronic terminal device 2 may be preferably mounted so as to slide along grooves 32 of the peripheral edge portion 31.

Besides, in this embodiment No. 1, an insertion portion 7 through which a hand or an arm of a user is inserted is defined by forming the handle portion 4 mounting rotatably to the mounting main body 3 via a rotation mechanism 6 and the arm portion 5 extending in an arch-shaped from both ends thereof integrally. An elastic contact portion 8 made of elastic material is provided on the insertion portion 7 of the arm portion 5 so as to come in contact with and fit to the hand or the arm of the user elastically.

### Embodiment No. 2

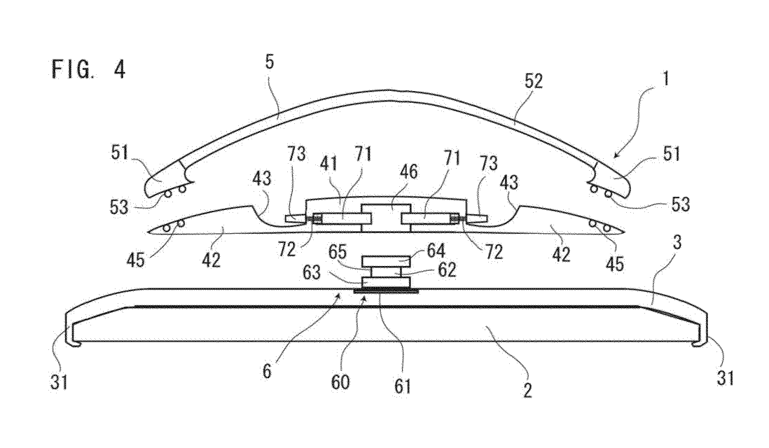

As shown in FIGS. 3 and 4, in the carrying case 1 according to the embodiment No. 2 of the present invention, the handle portion 4 is detachable to the mounting main body 3, and is characterized in that the arm portion 5 is detachable to the handle portion 4. Besides, in this embodiment No. 2, the handle portion 4 is formed with a specific thickness so as to be able to hold itself by the user and holding concave portion 44 are formed on side surfaces of an center portion 41 thereof so as to he easy to hold. Thus, the handle portion 4 is constituted of the center portion 41 and mounting extending portions 42 on which mound rig portions 51 are mounted, and further grooves for operation 43 in which knob portions 73 for being pulled in order to remove the handle portion 4 are extended thereon. Furthermore, in the center portion 41, a mounting hole 46 through which first and second disc portions 63, 64 of the following base portion 60 is formed.

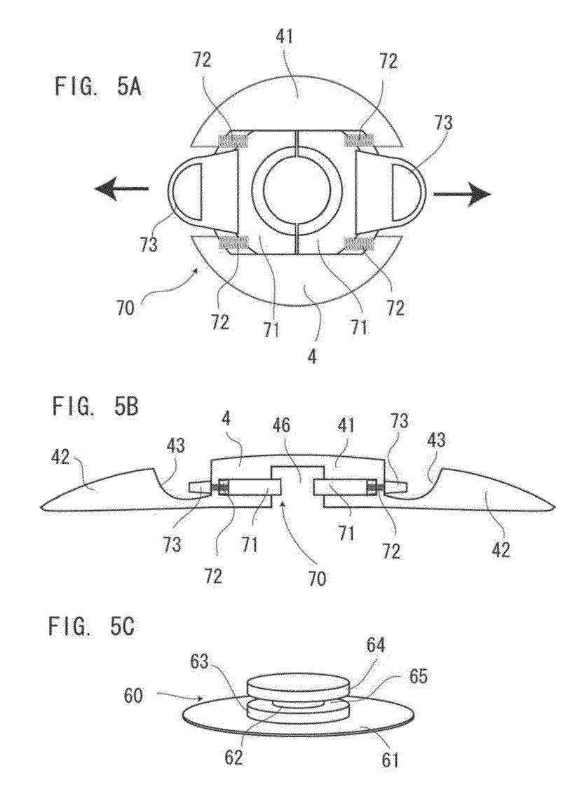

Besides, as shown in FIGS. 4 and 5, the rotation mechanism 6 has a detachable mechanism. The rotation mechanism 6 is constituted of a base portion 60 and a rotation fixing portion 70 engaging the base portion 60 and provided in the handle portion 4. The base portion 60 is constituted of embedment disc 61 embedded in the mounting main body 3, a shaft portion 62 extending from the embedment disc 61, first and second disc portions 63, 64 extending in radial direction from the shaft portion 62 and an engaged concave portion 65 formed between the first and second portions 63, 64. The rotation fixing portion 70 is constituted of engaging convex portions 71 movably mounted to the engaged concave portion 65, springs 72 biasing the engaging convex portions 71 against the engaged concave portion 65 and knob portions 73 which can be pulled in a direction so that the engaging convex portions 71 from the engaged concave portion 65. These knob portions 73 are extended into groove portions for operation 42 formed in the handle portion 4.

Besides, the arm portion 5 is constituted of mounting end portions 51 on which the mounting rail portions 53 inserting into mounting grooves 45 provided on the mounting extending portions 42 of the handle portion 4 and an elastic retaining portion 52 bridging between the mounting end portions 51, so that the arm portion 5 becomes detachable to the handle portion 4.

Due to the above constitution, the base portion 60 is inserted into the mounting hole 46 of the center portion 41 in the handle portion 4 in a condition of pulling the knob portions 73, and then due to releasing the knob portions, the engaging convex portions 71 connected to the knob portions are engaged into the engaged concave portion 65 by biasing of the springs 72, so that the handle portion 4 is rotatably mounted to the mounting main body 3. Besides, in the case of releasing the handle portion 4, an opposite process to the above mentioned process is performed.

### Embodiment No. 3

The carrying case 1 according to the embodiment No. 3 of the present invention is characterized in that a part of the arm portion 5 is held rotatably around one end of the part of the arm portion 5 and used as a stand portion 9 which can open at specific angles. Besides, the stand portion 9 can be used as a cover for a space defined in the arm portion 5, the space in the arm portion 5 can be used as a repository for earphone, and the space can be used as a repository for a chip for prepaid electronic money.

### EXPLANATION OF THE MARKS

1 Carrying Case
2 Portable Electronic Terminal Device
3 Mounting Main Body
4 Handle Portion
5 Arm Portion
6 Rotation Mechanism
7 Insertion Part
8 Elastic Contact Portion
9 Stand Portion

1. A carrying case characterized by comprising:
a mounting main body for mounting and fixing a portable electronic terminal device having a screen with a specific size which is an information displaying screen and a touch input screen;
a handle portion rotatably held to said mounting main body; and
an arm portion fixed on said handle portion and holding a hand or an arm of a user between the handle portion and itself.

2. A carrying case according to claim 1 characterized in that:
said arm portion is constituted of a bridge portion defining a space through which the hand or the arm of the user can be inserted and an elastic portion provided on said bridge portion and contacting the hand or the arm of the user elastically.

3. A carrying case according to claim 1 characterized in that:
said arm portion is constituted of a pair of fixing portions detachable to said handle portion and a belt portion positioned between said fixing portions and made of elastic material for holding the hand or the arm of the user, so that said arm portion is detachable to said handle portion.

4. A carrying case according to claim 1 characterized in that:
a part of said arm portion is a stand which is held rotatably around one end of said part of said arm portion and is opened at specific angles.

5. A carrying case according to claim 1 characterized in that:
said handle portion is detachable to said mounting main body.

6. A carrying case according to claim 2 characterized in that:
a part of said arm portion is a stand which is held rotatably around one end of said part of said arm portion and is opened at specific angles.

7. A carrying case according to claim 2 characterized in that:
said handle portion is detachable to said mounting main body.

8. A carrying case according to claim 3 characterized in that:
said handle portion is detachable to said mounting main body.

9. A carrying case according to claim 4 characterized in that:
said handle portion is detachable to said mounting main body.

10. A carrying case characterized by comprising a mounting main body for mounting and fixing a portable electronic terminal device having a screen with a specific size which is an information displaying screen and a touch input screen;
a handle portion rotatably held via a rotation mechanism and detachably via a detachment mechanism to said mounting main body, and having a center portion that is formed with specific thickness and on whose side surfaces concave portions are formed; and
an arm portion extending from both ends of said handle portion and fixed detachably to said handle portion, and defining an insertion portion through which a hand or an arm of a user passes between the handle portion and itself.

11. A carrying case according to claim 10 characterized in that:
said arm portion comprises an elastic portion contacting the hand or the arm of the user elastically.

12. A carrying case according to claim 11 characterized in that:
a part of said arm portion is a stand which is held rotatably around one end of said part of said arm portion and is opened at specific angles.
